(19) United States
(12) Patent Application Publication
(10) Pub. No.: US 2012/0313564 A1
(43) Pub. Date: Dec. 13, 2012

(54) RECONFIGURABLE INVERTER HAVING FAILURE TOLERANCE FOR POWERING A SYNCHRONOUS POLY-PHASE MOTOR HAVING PERMANENT MAGNETS, AND ASSEMBLY INCLUDING SAID INVERTER AND MOTOR

(75) Inventors: Jérémy Guitard, Paris (FR); Frédéric Richard, Paris (FR); Xavier Pol, Toulouse (FR)

(73) Assignee: ASTRIUM SAS, Paris (FR)

(21) Appl. No.: 13/518,505

(22) PCT Filed: Dec. 20, 2010
(86) PCT No.: PCT/EP2010/070256

§ 371 Date: Aug. 29, 2012

(30) Foreign Application Priority Data
Dec. 22, 2009 (FR) 09 59367

(51) Int. Cl. H02H 7/08

(52) U.S. Cl. 318/400.21

(57) ABSTRACT

Reconfigurable fault-tolerant inverter for powering a multi-phase synchronous permanent-magnet motor, and assembly of the said inverter and motor.

The inverter includes: N switching cells (B1, B2, B3) including switching devices (B11 to B32) and isolating devices (S11 to S33) where N is the number of phases of the motor (N≧3); at least one redundancy cell (R); a supervisor (12) to detect an operating anomaly of the inverter, leading to a stoppage of the motor (14), resulting from a failure of one of the N cells and causing a fault of one of the phases of the motor. Each switching device informs the supervisor of a short circuit affecting this device, and the supervisor supervises the integral value of the absolute value of the current in the defective phase.

### TECHNICAL FIELD

The present invention concerns a reconfigurable, fault-tolerant inverter, for powering a multi-phase (in particular three-phase) permanent-magnet synchronous motor together with an assembly of the said inverter and motor.

It applies notably to the aerospace field, and more specifically to the space field.

For more than two decades electricity has been growing in importance within space, aeronautical, motor vehicle and rail equipment. Indeed, the development of increasingly “electrical” space, air and land means of transport has shown that there is great potential for optimisation compared to the use of conventional actuation systems, principally through simplification of maintenance, improvement of efficiency and reduction of development and operating costs. In particular, the resultant change of energy architectures is leading to considerable emergence of power electronics.

In this context, the present invention concerns more specifically positioning or drive systems resulting from the combination of a DC-AC converter (inverter) and a synchronous permanent-magnet three-phase motor.

### STATE OF THE PRIOR ART

Although very much in fashion, the technological field of power electronics is critical to achieve sufficient reliability for such systems with high degrees of availability. Indeed, the topologies conventionally used for inverters do not enable operation to be maintained when the most common failure mode occurs: short-circuiting of one of the power switches contained in the inverter.

It should be recalled, indeed, that an inverter is a bridge structure which is generally constructed from power semiconductor switches such as IGBTs, i.e. insulated-gate bipolar transistors.

In order to satisfy the requirements of operational availability the present invention uses a fault-tolerant inverter topology, in which the inverter has structural redundancies.

FIG. 1 is a partial schematic view of a particular embodiment of a reconfigurable fault-tolerant voltage inverter, which can be used in the present invention.

On the subject of reconfigurable fault-tolerant voltage inverters, reference may notably be made to the following documents:
[1] FR 2 892 243, “Onduleur de tension reconfigurable”, an invention of Jérôme Mavier et al.,
[2] U.S. Pat. No. 7,436,686, corresponding to document [1],
[3] Thesis of Jérôme Mavier, “Convertisseurs génériques à tolérance de panne, applications pour le domaine aéronautique”, defended on 22 Mar. 2007.

In the example of FIG. 1 the reconfigurable fault-tolerant voltage inverter is intended to power a synchronous permanent-magnet three-phase motor (not represented). This inverter includes a switching system 2 including three switching cells B1, B2, B3, called “arms”, and another switching cell R, which constitutes a redundant cell, called a “redundant arm”.

Each of these three switching cells B1 or B2 or B3 includes two switching devices B11-B12 or B21-B22 or B31-B32 (power semiconductor switches) which are assembled in series. Each of these devices has first and second terminals, and the first terminals have a common point. The common points corresponding to arms B1, B2, B3 have the respective references P1, P2, P3. To power the motor, points P1, P2, P3 are connected respectively to phases φ1, φ2, φ3 of the motor.

Each of the three switching cells B1, B2, B3 also includes two isolating devices S11-S12 or S21-S22 or S31-S32 (isolating switches), each of which has first and second terminals. The first terminals are intended to be connected respectively to the two terminals V1, V2 of a direct voltage source (not represented). The two terminals are connected respectively to the second terminals of associated switching devices B11-B12 or B21-B22 or B31-B32.

Redundancy cell R includes two switching devices R1, R2 (power semiconductor switches) which are assembled in series. Each of these devices has first and second terminals. The first terminals have a common point P4. The second terminals are intended to be connected respectively to the two terminals V1, V2 of the direct voltage source.

Redundancy cell R also includes three connection devices 4, 6, 8 (connection switches), each having first and second terminals. The first terminals are connected to common point P4 and the second terminals are intended to be connected respectively to the three phases φ1, φ2, φ3 of the motor.

The operating principle of the inverter represented in FIG. 1 is simple: in the event of a fault the defective arm, namely B1 or B2 or B3, is completely isolated by associated switches B11-B12 or B21-B22 or B31-B32, and redundant arm R replaces the defective arm.

This fault-tolerant inverter topology requires a redundancy-management device (not represented in FIG. 1), called a “supervisor”. The latter is designed to:
detect an operating anomaly of the inverter leading to the stoppage of the motor powered by the inverter, which results from the failure of one of the three arms B1, B2, B3, and which causes a fault of one of the phases of the motor,
isolate the defective arm,
determine the cause of the failure, and
order a restart of the motor or a reconfiguration of the inverter, appropriate for the detected anomaly.

The responsiveness of this supervisor is crucial to prevent the fault from propagating, and also to correct this fault as rapidly as possible, in order that the mission of a system containing the inverter and the motor powered by the latter is not affected by the malfunction.

### DESCRIPTION OF THE INVENTION

The object of the present invention is precisely an inverter which has a supervisor of great responsiveness.

More precisely, the object of the present invention is a reconfigurable fault-tolerant voltage inverter, intended to power a multi-phase synchronous permanent-magnet motor, where the number of phases of the motor is equal to N, where N is an integer which is at least equal to 3, and where the inverter includes:
first to N^{th} switching cells, where each includes:
   two switching devices assembled in series, and
   two isolating devices,
at least one N+1^{th} switching cell, constituting a redundancy cell, and
a redundancy-management device, adapted to
   detect an operating anomaly of the inverter, leading to a stoppage of the motor, which results from a failure of one of the first to N^{th} switching cells, and which causes a fault of one of the N phases of the motor,
   isolate the defective switching cell,
   determine the cause of the failure, and
   order a restart of the motor or a reconfiguration of the inverter, appropriate for the detected anomaly,

in which each switching device is adapted to inform the redundancy-management device of a short circuit affecting this switching device, and in which the redundancy-management device is also adapted to supervise the integral value of the absolute value of the current in the defective phase.

According to a preferred embodiment of the inverter forming the object of the invention,
in the first to N^{th} switching cells, the two switching devices assembled in series each have first and second terminals, where the first terminals have a common point, intended to be connected to one of the N phases of the motor, and the two isolating devices each have first and second terminals, where the first terminals are intended to be connected respectively to the two terminals of a direct voltage source, and where the second terminals are connected respectively to the two terminals of the associated switching devices.

In this case the N+1^{th} switching cell constituting a redundancy cell preferably includes:
two switching devices assembled in series, where each has first and second terminals, where the first terminals have a common point, where the second terminals are intended to be respectively connected to the two terminals of the direct voltage source, and
N connection devices each having first and second terminals, where the first terminals are connected to the common point corresponding to the N+1^{th} switching cell, where each of the two terminals is intended to be connected to one of the N phases of the motor.

Moreover, the redundancy-management device is preferably adapted to compare the supervised integral value with a predetermined threshold.

According to a preferred embodiment of the invention, the redundancy-management device is moreover adapted to order the electrical isolation of one of the N−1 phases of the motor, which has no fault, as soon as the fault is detected.

In this case the redundancy management device is also preferably adapted to order the opening of the first of the N−1 fault-free phases, the current of which passes through zero.

According to a particular embodiment of the invention, the redundancy-management device is also adapted to order the reconfiguration of the inverter as soon as a predetermined number of restarts of the motor is reached.

The present invention also concerns a multi-phase synchronous permanent-magnet fault-tolerant inverter-motor assembly, including:
the inverter forming the object of the invention, and
a multi-phase synchronous permanent-magnet motor powered by the inverter.

The invention also concerns a method of redundancy management in a reconfigurable fault-tolerant voltage inverter, intended to power a multi-phase synchronous permanent-magnet motor, where the number of phases of the motor is equal to N, where N is an integer which is at least equal to 3, and where the inverter includes:
first to N^{th} switching cells, where each includes:
   two switching devices (B11-B12, B21-B22, B31-B32) assembled in series, and
   two isolating devices,
at least one N+1^{th} switching cell, constituting a redundancy cell, and
a redundancy-management device, in which
   an operating anomaly of the inverter is detected, leading to a stoppage of the motor, which results from a failure of one of the first to N^{th} switching cells, and which causes a fault of one of the N phases of the motor,
   the defective switching cell is isolated,
   the cause of the failure is determined, and
   a restart of the motor or a reconfiguration of the inverter, appropriate for the detected anomaly, is ordered,

in which each switching device informs the redundancy-management device of a short circuit affecting this switching device, and in which the redundancy-management device supervises the integral value of the absolute value of the current in the defective phase.

### BRIEF DESCRIPTION OF THE DRAWINGS

The present invention will be better understood on reading the description of example embodiments given below, purely as an indication and in no way limitative, making reference to the appended drawings in which:

FIG. 1 is a partial schematic view of a particular embodiment of a reconfigurable fault-tolerant voltage inverter, which can be used in the present invention, and has previously been described,

FIG. 2 is a schematic view of a particular embodiment of the reconfigurable fault-tolerant inverter forming the object of the invention, and

FIG. 3 is a timing diagram of the method which is implemented in the invention.

### DETAILED ACCOUNT OF PARTICULAR EMBODIMENTS

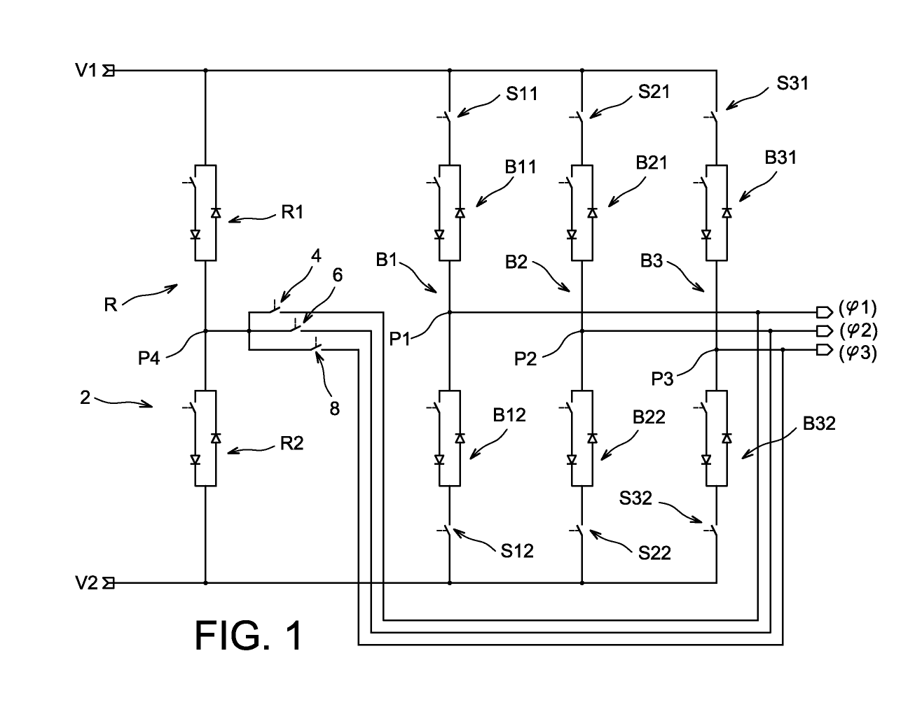

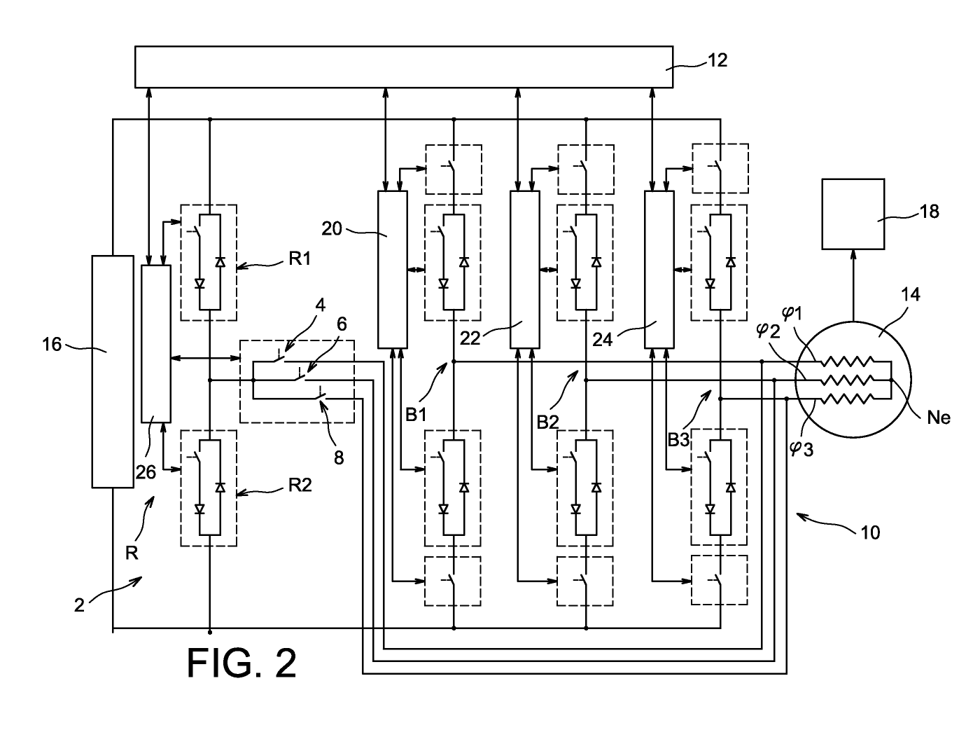

FIG. 2 is a schematic view of a particular embodiment of the voltage inverter forming the object of the invention. Voltage inverter 10 represented in FIG. 2 includes:
switching assembly 2 which was described in referring to FIG. 1, and
a redundancy-management device 12, also called a “supervisor”.

Inverter 10 powers a three-phase synchronous permanent-magnet motor 14, and it is itself powered by a direct voltage source 16.

Purely as an indication and in no way limitative, and in no way restrictively, the function of motor 14 is to control an actuator 18, for example a control surface servo of a spacecraft.

The supervisor is designed to detect and correct both types of malfunction which can affect one of the power switches included in cells B1, B2 and B3 of the inverter: a malfunction of the short circuit type, or a malfunction of the open circuit type. The most critical failure mode is the short circuit. It is also, unfortunately, the more frequent of the two. In what follows this case of a short circuit will be considered. And it will be explained how supervisor 12 manages a malfunction of the short-circuited switch type.

When a power switch is short-circuited a very high current (of the order of five times the nominal current, for example) flows through it, the power switch departs from its linear operating zone and enters its desaturation zone.

It is stipulated that each switching cell B1 or B2 or B3 of inverter 10 has a driver circuit 20 or 22 or 24 constituting a device for close control and supervision of this switching cell and of isolating devices associated with this cell. Switching cell R, for its part, has a driver circuit 26 constituting a device for close control and supervision of this switching cell and of connection devices 4, 6, 8.

Driver circuits 20, 22, 24 and 26 communicate with supervisor 12. On this subject, reference will notably be made to documents [1] (or [2]) and [3].

When one of the power switches departs from its linear operating zone the driver circuit to which it corresponds is able to detect this departure from linear operation, and to send a flag to supervisor 12. The latter then orders, as rapidly as possible, a blockage of the switch and its complement, i.e. the second switch of the arm including the short-circuited switch.

It is accepted in what follows that a malfunction is always followed by the despatch of this flag, which enables the supervisor to initiate the malfunction-management procedure.

In order to limit the high currents of the fault state in question, a blockage order, or inhibition order, of the inverter is sent by supervisor 12 as soon as it receives a flag. This means that the opening (or inhibition) of the six switches of the arms B1, B2 and B3 of the inverter is requested as soon as possible.

The latter is then in one of the following two configurations: either the inverter is indeed blocked, or one of the six switches is still short-circuited.

If the inverter is indeed blocked, this means that the driver circuit was able to cause each of the switches to open: all six switches are open. The despatch of the flag proves to be a “false malfunction” since the switch having caused the signal to be sent can still be controlled.

An effective cancellation of the currents follows, including in the phase supposed to be defective (one of phases φ1, φ2 and φ3 of motor 14). After this false malfunction motor 14 can be restarted with the same configuration, since the cell is not genuinely defective: the short circuit could result from a control fault.

However, this fault may be repeated, and may disrupt the satisfactory operation of actuator 18 which is controlled by motor 14.

To prevent this, the user can record a maximum number of restarts in supervisor 12, and configure the latter such that, when this number is reached, the supervisor reconfigures the inverter, whether the malfunction is “false” or “real”.

If one of the six switches is still short-circuited this means that the internal procedure of the driver circuit did not function as intended. It is stipulated that this internal procedure consists in automatically opening (or inhibiting) the switch (a very localised procedure).

This is then the genuine critical mode, which must be diagnosed as rapidly as possible. The diagnosis may be established by supervisor 12 by observing the current in the defective phase, a current which is supposed to be cancelled for a substantial time (after the blockage of the inverter), whereas in this case of a malfunction this current becomes uncontrollable and can reach high values (higher than the nominal current).

The current in the defective phase can be observed by means of the phase current sensors which are required for nominal operation.

When the diagnosis has been correctly made the supervisor must order isolation of the defective arm, check that this isolation has indeed occurred, and finally reconfigure the inverter using redundant arm R.

This process poses two major problems:

1) For the supervisor, the fact that a current “is cancelled for a substantial time” must be translated. This aspect is necessary for the diagnosis, but very difficult to translate in quantitative terms, for the following reasons:
a) At the start of the blockage the instantaneous averages of the currents are non-zero. The test cannot therefore be made at that time. It is very difficult to evaluate after how much time a diagnosis becomes valid.
b) Due to the noise of the current sensors, which are positioned close to switching cells B1, B2, B3, and designed for nominal operation, it cannot be hoped that a simple cancellation test can be carried out; otherwise, margins must be calibrated around zero, which margins can distort the diagnosis in certain cases.
c) The phrase “for a substantial time” poses a problem: the duration of the diagnosis must be as short as possible, but must also be sufficiently long to give a high degree of confidence.

2) Once the diagnosis has been made and the decision to reconfigure the inverter has been taken, it must be possible to isolate the faulty phase using the corresponding isolating switches (as an example, this concerns switches S11 and S12 if phase φ1 is defective). But these switches have no cutoff power. In other words, they can be opened only when the current flowing through them is zero. And in the “blocked inverter” position there is no guarantee that the currents in the faulty phase will pass through zero. This is due to the permanent magnets of the motor which can maintain the fault state.

The present invention seeks to resolve these two problems.

In the invention, in order to assess whether the current in the faulty phase “is cancelled for a substantial time”, the integral value of the absolute value of the current of the faulty phase is supervised. This enables not only the transient regime of the start of the diagnosis when the inverter is blocked to be filtered, but also the current measuring noises.

In addition, it is advantageous to compare this integral value with a predetermined threshold. This enables a fast diagnosis to be made, without any supervision “sliding window”, and without being obliged to determine a precise diagnosis date. Otherwise, this diagnosis date would have to be confirmed several times, in order to have a high degree of confidence in the decision.

In other words, due to the notion of an integral value, the diagnosis is not dependent on a moment of decision, which prevents prohibitive tolerance margins from having to be set.

It is explained below how the integral value of the absolute value of the current in the faulty phase is supervised.

The instantaneous values of the current phases are available in the electronic control means which control the inverter, since these values are required to control the inverter.

In addition, producing the integral value of an absolute value is a computational operation which is easy to implement in supervisor 12.

In addition, in the invention, in order to be certain that the current in the faulty phase will be cancelled, the isolation of a healthy phase is ordered, on detection of the fault. When the request to block the inverter is made, and even before having terminated the diagnosis, the first healthy phase, the current of which passes through zero, is opened using the isolating switches. Kirchhoff's current law at neutral point Ne of motor 14 and the variations of the counter electromotive forces of the motor then cause the currents in the two remaining phases to pass through zero, and to do so very rapidly (less than one mechanical revolution of the motor). By this time the diagnosis will have had the time to be completed, and the moment when the currents are cancelled will allow the faulty phase to be isolated, followed by the reconfiguration and restart of the system.

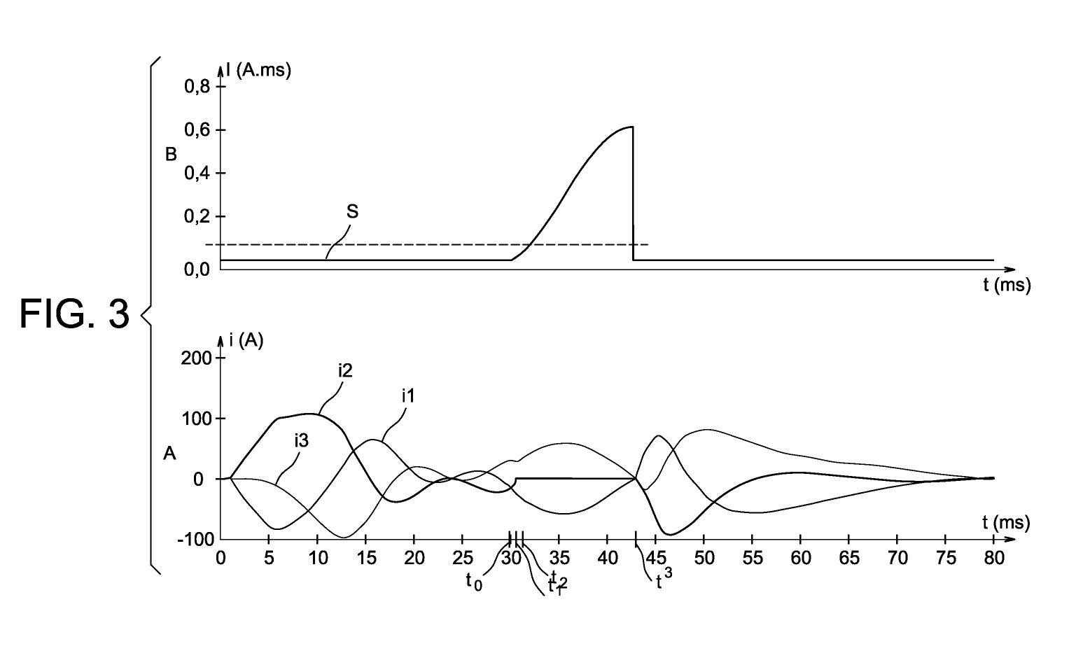

A timing diagram of the method implemented in the example of the invention, which has been described, is shown in FIG. 3.

In this FIG. 3 time t is measured along the abscissa, and expressed in milliseconds. In part A of FIG. 3 values i of the currents in question are shown in the ordinate, and expressed in amperes.

In this part A the three currents i1, i2, i3 which are supplied by the inverter of FIG. 2, and which flow in the connections of motor 14, have been represented. It is supposed that a short circuit appears in arm B1 of the inverter, at an instant tₒ=30 ms after the instant chosen as the origin in FIG. 3.

Part B of FIG. 3 represents the variations I (in A·ms) of the integral value of the absolute value of the current in the faulty phase (φ1 in the example) as a function of time t. Dotted line S corresponds to the predetermined threshold, mentioned above.

Instant tₒ+500 ns (approximately) corresponds to the instant at which the driver circuit is alerted to the appearance of the short circuit in arm B1 of the inverter, and at which the inverter is blocked.

Instant t1, not very different from 31 ms, corresponds to the cancellation of the current (i2 in the represented example) in one of the two healthy phases, and to the isolation of this phase.

Instant t2, not very different from 32 ms, corresponds to the time at which integral I exceeds threshold value S.

Instant t3, not very different from 43 ms, corresponds to the time at which the current in the defective phase is cancelled, this phase is isolated, and connection of healthy arms B2, B3 and of redundant arm R occurs.

In what follows some advantages of the present invention are mentioned:

1) The method used in the invention enables the fault to be isolated (this fault is not propagated), and allows the diagnosis, reconfiguration and finally restart of the operation of the system formed by the inverter and the motor.

2) The method operates in real time in the system, implying excellent responsiveness, and enables, for example, an almost uninterrupted continuation of the mission of a spacecraft having such a system; indeed, the procedure typically lasts between 5 ms and 50 ms in the case of applications for space control surface servos.

3) The principle of the method is very simple. It requires no major computer resources, or complex mathematical tools.

4) It causes a significant increase of the reliability of a three-phase DC-AC converter, intended to power a synchronous permanent-magnet machine: the hourly malfunction rate is cut approximately by 100.

5) Of all the solutions proposed to improve the reliability of three-phase inverters the invention has one of the best additional cost/performance compromises.

6) Unlike many other known solutions to resolve this problem, with the invention the operating regime after reconfiguration is identical to the initial regime. In other words, the back-up mode is not “degraded”.

7) The examples which have been given of the invention can be extended as desired to be tolerant to the desired number of malfunctions. The method is unchanged: other redundant arms need merely be added, assembled in parallel with arm R of FIG. 2.

8) The process described is “transparent” for all servocontrol loops contained in the control laws of the converter-motor assembly. This means that this method does not require that these control laws are modified.

9) The described process does not imply any oversizing, or any modification of the design of the motor. For example, many known processes in this field require physical access to neutral point Ne of the motor, which is not the case with the invention.

10) This process requires no additional physical sensor, specific to its implementation: this process simply uses sensors which conventionally form part of known three-phase synchronous permanent-magnet inverter-motor assemblies, namely the motor's phase current sensors and the motor's position sensor.

11) The reconfiguration of the inverter is reversible: the present invention uses no single-use elements, such as a fuse. It makes it possible to check that redundancy is operational during functional tests.

In order to facilitate maintenance operations the inverter-motor assembly is advantageously designed such that it automatically provides information concerning its state: thus, no diagnosis must be made by the operator to know whether redundancy has been consumed. In order to provide this information the supervisor has a software memory which it can share with other software responsible for maintenance.

In the examples given of the invention which refer to FIGS. 2 and 3 the motor is three-phase. But there could be more than three phases, for example in the case of applications requiring high power: the present invention applies more generally to the case in which the motor has N phases, where N is greater than 3. The skilled man in the art can adapt the examples given above to such a case: instead of including three cells in parallel, N such cells are included; and instead of including three switches in each redundancy cell (switches 4, 6, 8 in FIGS. 1 and 2), N such switches are included.

1-9. (canceled)

10. A reconfigurable fault-tolerant voltage inverter, intended to power a multi-phase synchronous permanent-magnet motor, where the number of phases of the motor is equal to N, where N is an integer which is at least equal to 3, and where the inverter includes:
first to N^{th} switching cells, where each includes:
two switching devices assembled in series, and
two isolating devices,
at least one N+1^{th} switching cell, constituting a redundancy cell, and
a redundancy-management device, adapted to
detect an operating anomaly of the inverter, leading to a stoppage of the motor, which results from a failure of one of the first to N^{th} switching cells, and which causes a fault of one of the N phases of the motor,
isolate the defective switching cell,
determine the cause of the failure, and
order a restart of the motor or a reconfiguration of the inverter, appropriate for the detected anomaly,
in which each switching device is adapted to inform the redundancy-management device of a short circuit affecting this switching device, and in which the redundancy-management device is also adapted to supervise the integral value of the absolute value of the current in the defective phase.

11. An inverter according to claim 10, in which in the first to N^{th} switching cells the two switching devices assembled in series each have first and second terminals, where the first terminals have a common point, intended to be connected to one of the N phases of the motor, and the two isolating devices each have first and second terminals, where the first terminals are intended to be connected respectively to the two terminals of a direct voltage source, and where the second terminals are connected respectively to the two terminals of the associated switching devices.

12. An inverter according to claim 11 in which the N+1^{th} switching cell, constituting a redundancy cell, includes:
two switching devices assembled in series, where each has first and second terminals, where the first terminals have a common point, where the second terminals are intended to be respectively connected to the two terminals of the direct voltage source, and
N connection devices each having first and second terminals, where the first terminals are connected to the common point corresponding to the N+1^{th} switching cell, where each of the two terminals is intended to be connected to one of the N phases of the motor.

13. An inverter according to claim 10, in which the redundancy-management device is also adapted to compare the supervised integral value with a predetermined threshold.

14. An inverter according to claim 10, in which the redundancy-management device is moreover adapted to order the electrical isolation of one of the N−1 phases of the motor, which has no fault, as soon as the fault is detected.

15. An inverter according to claim 14, in which the redundancy management device is also adapted to order the opening of the first of the N−1 fault-free phases, the current of which passes through zero.

16. An inverter according to claim 10, in which the redundancy-management device is also adapted to order the reconfiguration of the inverter as soon as a predetermined number of restarts of the motor is reached.

17. A multiphase synchronous permanent-magnet fault-tolerant inverter-motor assembly including:
the inverter according to claim 10, and
a multi-phase synchronous permanent-magnet motor, powered by the inverter.

18. A redundancy management method in a reconfigurable fault-tolerant voltage inverter, intended to power a multi-phase synchronous permanent-magnet motor, where the number of phases of the motor is equal to N, where N is an integer which is at least equal to 3, and where the inverter includes:
first to N^{th} switching cells, where each includes:
two switching devices assembled in series, and
two isolating devices,
at least one N+1^{th} switching cell, constituting a redundancy cell, and
a redundancy-management device, in which
an operating anomaly of the inverter is detected, leading to a stoppage of the motor, which results from a failure of one of the first to N^{th} switching cells, and which causes a fault of one of the N phases of the motor,
the defective switching cell is isolated,
the cause of the failure is determined, and
a restart of the motor or a reconfiguration of the inverter, appropriate for the detected anomaly, is ordered,
in which each switching device informs the redundancy-management device of a short circuit affecting this switching device, and in which the redundancy-management device supervises the integral value of the absolute value of the current in the defective phase.
